(19) United States
(12) Patent Application Publication
(10) Pub. No.: US 2006/0271739 A1
(43) Pub. Date: Nov. 30, 2006

(54) Management of transfer of commands

(76) Inventors: Shu-Fang Tsai, Hsinchu City (TW); Yi-Chuan Chen, Taipei City (TW); Kuo-Chang Li, Hsinchu City (TW); Chih-Chiang Wen, Hsinchu County (TW); Hsieh Te-Ching, Hsinchu City (TW)

Correspondence Address: FISH & RICHARDSON PC, P.O. BOX 1022, MINNEAPOLIS, MN, 55440-1022, US

(21) Appl. No.: 11/220,819

(22) Filed: Sep. 7, 2005

Related U.S. Application Data
(60) Provisional application No. 60/683,954, filed on May 24, 2005.

(51) Int. Cl. G06F 13/00; G06F 13/28

(52) U.S. Cl. 711/123; 711/113

(57) ABSTRACT

An optical storage device that includes a memory and a controller. The memory includes a command queue to store advanced technology attachment (ATA) commands sent by a host device. The controller executes the commands, in which at least a subset of the commands are executed in a sequence that is different from a sequence in which the commands are sent by the host device.

### CROSS-REFERENCE TO RELATED APPLICATIONS

This application claims priority to U.S. Provisional Application No. 60/683,954, filed May 24, 2005, incorporated herein by reference.

### BACKGROUND

This description relates to management of transfer of commands.

FIG. 1 shows a data processing system 10 in which a host computer 12 communicates with an optical disc drive 14 through an integrated device electronics (IDE) bus 16. The IDE bus 16 has one end that is connected to an IDE/advanced technology attachment (ATA) controller 18 of the disc drive 14, and another end that is connected to a host adapter 15 of the host computer 12. The controller 18 controls transfers of commands and data through the IDE bus 16 in response to requests initiated by the host computer 12 through the host adapter 15. The disc drive 14 includes a disc controller chipset 20 to control a spindle motor 22 and a pickup head 24 to transfer data to and from locations on an optical disc 26.

Transfers of data to and from the disc 26 involve mechanical movements of a pickup head 24, which causes the speed of data transfer to and from the disc 26 to be slower than the speed of data transfer between the host computer 12 and the disc drive 14 through the IDE bus 16. A dynamic random access memory (DRAM) 28 provides temporary storage of data read from the disc 26, allowing faster access to data that was recently accessed. Access to the DRAM 28 is managed by a DRAM controller 29.

The host computer 12 sends commands to the disc drive 14 to access data on the disc 26. The commands comply with AT attachment packet interface (ATAPI) standard, and each may include up to 12 bytes, referred to as a command packet. Each command packet may include a command code and command parameters. For example, a command packet for a read or write operation may include an operation code, a logical block address, and a data transfer length. Each command packet is received by the IDE/ATA controller 18 and stored in a register 19 of the controller 18. A microcontroller 31 reads the command packet from the register 19 and executes the command in cooperation with the disc controller chipset 20.

### SUMMARY

In one aspect, the invention features an optical storage device includes a memory, the memory including a command queue to store advanced technology attachment (ATA) commands sent by a host device, and a controller capable of executing the commands such that at least a subset of the commands are executed in a sequence that is different from a sequence in which the commands are sent by the host device.

Implementations of the invention may include one or more of the following features. The controller executes the commands in a sequence that tends to reduce the total amount of time required for executing the commands. The controller executes the commands in a sequence that tends to reduce the total amount of distance traveled by a pickup head of the optical storage device when executing the commands. In one example, the optical storage device includes a second controller to control transfers of the commands to the command queue. The second controller, upon receiving a new command, searches for a location in the command queue in which a command previously stored at the location has already been executed, and stores the new command in the location. In an alternative example, the controller also controls transfers of commands to the command queue. The controller, upon receiving a new command, searches for a location in the command queue in which a command previously stored at the location has already been executed, and stores the new command in the location. In one example, the optical storage device includes a serial ATA (SATA) interface, in which the commands from the host device are transmitted to the optical storage device through the SATA interface. In an alternative example, the optical storage device includes a parallel ATA (PATA) interface, in which the commands from the host device are transmitted to the optical storage device through the PATA interface. The optical storage device includes a command queue reader to read the commands from the command queue and forward the commands to a command/data port, in which the controller reads the commands from the command/data port. The ATA commands includes ATA packet interface (ATAPI) command packets.

In another aspect, the invention features an apparatus that includes a command controller to manage transfer of a command packet from a data bus to a memory by sending a request to a memory controller requesting the memory controller to store the command packet or a portion of the command packet into the memory, the command controller being capable of sending the request in a higher priority than another request to the memory controller.

Implementations of the invention may include one or more of the following features. The data bus complies with at least one of a serial AT attachment (ATA) interface standard and a parallel ATA interface standard. The memory includes a cache memory of a storage device. The storage device includes at least one of a hard disk drive and an optical disc drive. The apparatus of claim 14 in which the command packets include at least one of a read data command to read data from the storage device and a write data command to write data to the storage device. The apparatus includes a memory arbiter to arbitrate which request to access the memory is executed by the memory controller, the arbitration based at least in part on the priority of the request. The memory includes at least one of dynamic random access memory and static random access memory. The memory includes a command queue to store multiple command packets. The command controller prevents the apparatus from entering a stand-by or sleep mode before the command packet is stored into the memory.

In another aspect, the invention features an apparatus that includes a storage device, a memory, a memory controller to control access to the memory, and a command controller to manage transfers of command packets from a data bus to the memory, the command controller sending a request to the memory controller to request a command packet or a portion of the command packet to be stored in the memory, the command controller being capable of adjusting a priority level of the request over time, and the command packets including at least one of a read command to read data from the storage device and a write command to write data to the storage device.

Implementations of the invention may include one or more of the following features. If the command packet is not processed by the memory controller after a period of time, the command controller increases the priority level of the request. The data bus complies with at least one of a serial AT attachment (ATA) interface standard and a parallel ATA interface standard. The apparatus includes a memory arbiter to arbitrate which request to access the memory is sent to the memory controller, the arbitration based at least in part on priority levels of the requests. The memory includes at least one of dynamic random access memory and static random access memory. The storage device includes at least one of a hard disk drive and an optical disc drive. The memory includes a cache memory, at least a portion of the memory to temporarily store data to be written to the storage device and data read from the storage device. The apparatus includes a host computer that accesses the storage device using the data bus.

In another aspect, the invention features a storage device that includes a command queue to store command packets that are received from a host device and are used to control an operation of the storage device, the command queue having a variable size, and a controller to determine the size of the command queue based on predetermined criteria.

Implementations of the invention may include one or more of the following features. The storage device includes at least one of a hard disk drive and an optical disc drive. The command queue is part of a random access memory, and the controller determines the size of the command queue based on an available amount of free space in the random access memory. The controller determines the size of the command queue based on historic data relating performance of the storage device to the size of the command queue.

In another aspect, the invention features a method that includes receiving advanced technology attachment (ATA) commands at an optical storage device having a memory, storing the commands in a command queue in the memory, and executing the commands, at least a subset of the commands being executed in a sequence that is different from a sequence in which the commands are received at the optical storage device.

Implementations of the invention may include one or more of the following features. Executing the commands includes executing the commands in a sequence that tends to reduce the total amount of distance traveled by a pickup head of the optical storage device when executing the commands. Executing the commands includes executing the commands in a sequence that tends to reduce the total amount of time required for executing the commands. The method includes, upon receiving a new command, searches for a location in the command queue in which a command previously stored at the location has already been executed, and stores the new command in the location. In one example, the method includes sending the commands to the optical storage device through a serial ATA interface. In another example, the method includes sending the commands to the optical storage device through a parallel ATA interface. The method includes reading the commands from the command queue, forwarding the commands to a command/data port, and using the controller to read the commands from the command/data port. If the command includes a write command, executing the command includes writing all data to the optical storage medium as instructed by the command. If the command includes a read command, executing the command includes reading all data from the optical storage medium as instructed by the command. The ATA commands includes ATA packet interface (ATAPI) command packets.

In another aspect, the invention features a method that includes sending a request to a memory controller that controls access to a memory to request the memory controller to store a command packet or a portion of the command packet in the memory, and if the command packet or a portion of the command packet is not processed by the memory controller after a period of time, increasing a priority level of the request.

Implementations of the invention may include one or more of the following features. The command packet controls an operation of a peripheral device that includes the memory. The method includes receiving the command packet from a data bus that is compatible with at least one of a serial AT attachment (ATA) interface standard and a parallel ATA interface standard. The command packet is sent from a host computer to the data bus, and the memory controller and the memory are disposed at a peripheral device. The peripheral device includes at least one of a hard disk drive and an optical disc drive. The peripheral device enters a sleep mode in which power consumption is reduced. The method includes preventing the peripheral device from entering the sleep mode before the command packet is stored in the memory. The command packets include at least one of a read data command to read data from a storage device and a write data command to write data to the storage device. The method includes sending more than one request to the memory controller, and arbitrating the requests to determine a sequence in which the requests are executed by the memory controller, the arbitration based at least in part on the priorities of the requests. The method includes storing the command packets in a command queue that can simultaneously store multiple commands. The method includes successively increasing the priority level of the request until the command packet or a portion of the command packet is processed by the memory controller.

In another aspect, the invention features a method that includes preventing a peripheral device to enter a sleep mode before a command packet received by the peripheral device is saved in a memory, wherein the peripheral device has a command controller to manage transfers of command packets from the host device to the memory by sending requests to a memory controller requesting the memory controller to store the command packets or portion of the command packets in the memory, the command controller being capable of adjusting priority levels of the requests.

Implementations of the invention may include one or more of the following features. The peripheral device includes at least one of a hard disk drive and an optical disc drive. The method includes receiving the command packets through a data bus that is compatible with at least one of a serial AT attachment (ATA) interface standard and a parallel ATA interface standard.

In another aspect, the invention features a method that includes determining a size of a command queue for storing command packets received at a peripheral device and sent from a host device, the peripheral device having a memory, the command packets including commands for controlling an operation of the peripheral device, and allocating a portion of the memory to store the command queue.

Implementations of the invention may include one or more of the following features. The peripheral device includes at least one of a hard disk drive and an optical disc drive. The size of the command queue is determined based at least in part on an available amount of free space in the memory. The size of the command queue is determined based at least in part on historic data relating performance of the peripheral device to the size of the command queue. The method includes executing the command packets in the memory in a sequence that is different from a sequence in which the command packets are received at the peripheral device.

Other features and advantages of the invention will be apparent from the description and drawings, and from the claims.

### DESCRIPTION OF DRAWINGS

FIGS. 1 and 2 show data processing systems.

FIG. 3 shows a block diagram of a DRAM and a circuit for controlling transfers of command packets from a data bus to the DRAM.

FIG. 4 shows a command queue.

FIG. 5 shows graphs of signals associated with transfers of command packets.

FIG. 6 shows a command queue.

### DETAILED DESCRIPTION

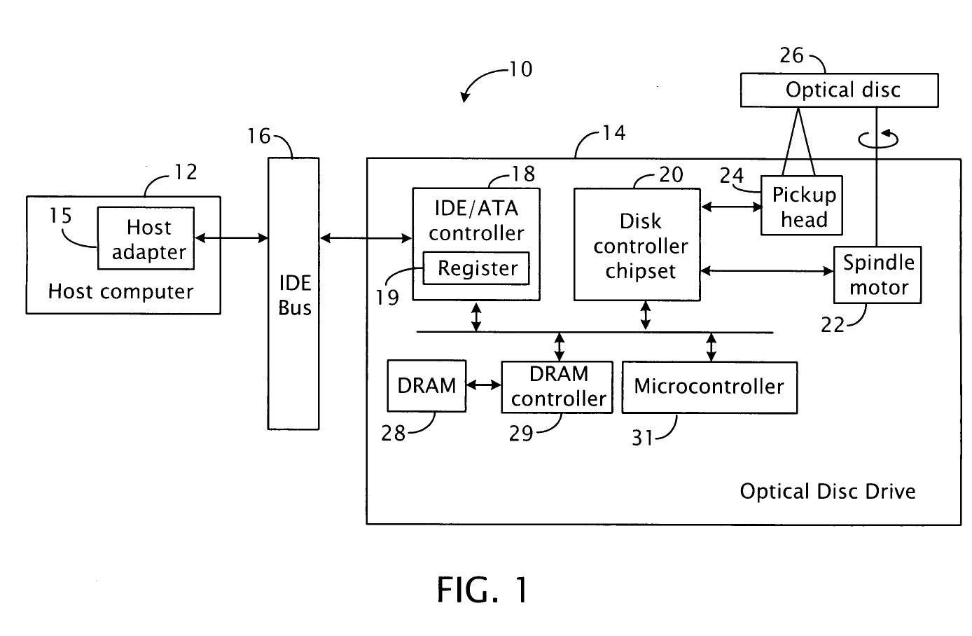

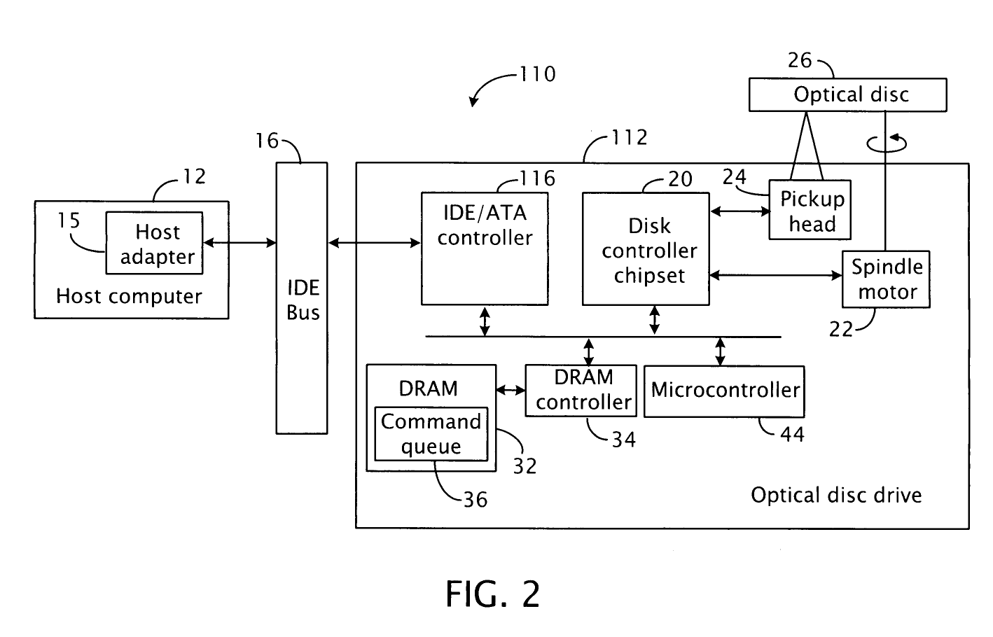

FIG. 2 shows an example of a data processing system 110 that stores command packets in a command queue 36 in a DRAM 32. Compared with the system 10 of FIG. 1, in which one command packet is stored in the register 19 of the IDE/ATA controller 18, the system 110 stores multiple command packets in the command queue 36. By storing multiple command packets in the command queue 36, a microcontroller 44 can read multiple command packets and rearrange the order of execution of the command packets to achieve a higher efficiency in accessing the disc 26.

For example, the host computer 12 may send command packets that request access to data located at different parts of the disc 26. A sequence of first, second, third, and fourth command packets may request access to data stored at the 10th, 300th, 100th, and 500th tracks, respectively. The lower number tracks are located radially closer to a center hole of the disc 26, whereas the higher number tracks are located radially farther away from the center hole. If the command packets were executed in the sequence they were received, which requires accessing the 10th, 300th, 100th, and 500th tracks in sequence, the pickup head 24 would have to move radially outwards from the 10th track to the 300th track, move radially inwards from the 300th track to the 100th track, then move radially outwards again from the 100th track to the 500th track.

To reduce the back-and-forth movement of the pickup head 24, the microcontroller 44 reads a number of command packets from the command queue 36, and determines a sequence for executing the command packets that is more efficient. In this case, the microcontroller 44 executes the command packets in a sequence so that the 10th, 100th, 300th, and 500th tracks are accessed sequentially. Because the pickup head 24 travels less distance and does not have to reverse the direction of movement (from moving radially inwards to outwards, and vice versa) several times, data can be read from the disc 26 faster.

Similarly, the microcontroller 44 may re-order the command packets for writing data to the disc 26 to reduce the movement of the pickup head 24. The microcontroller 44 may interleave the command packets for read and write operations to increase data throughput. Various ways of re-ordering the command packets may be used.

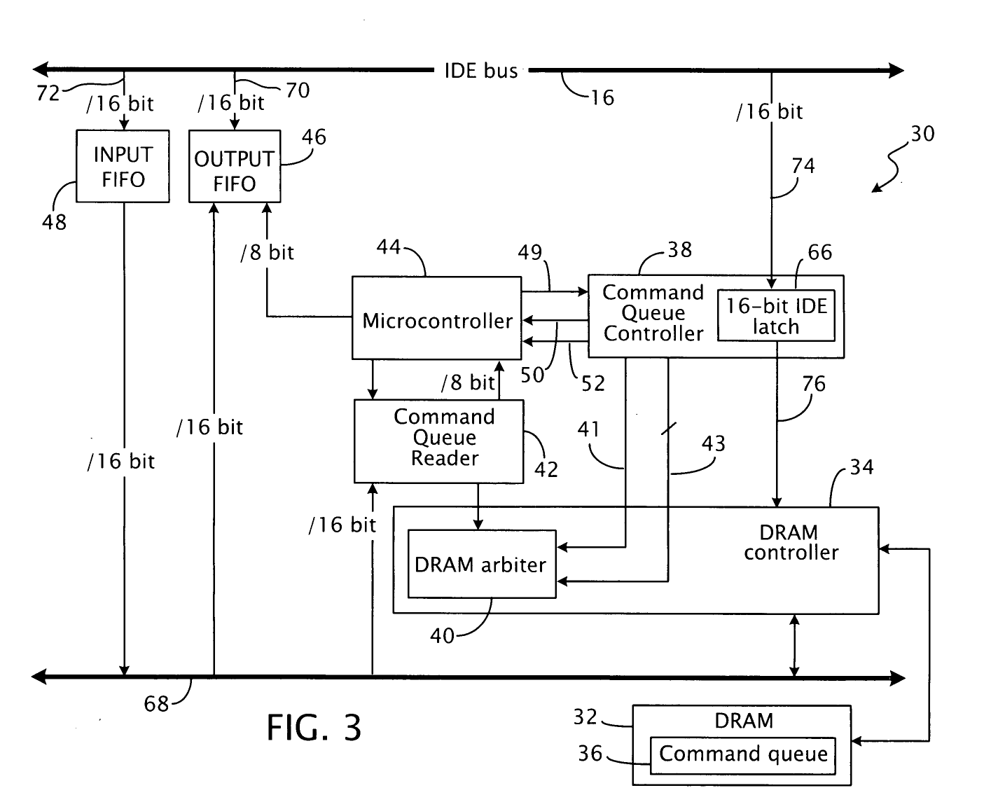

FIG. 3 shows a block diagram of an example of a circuit 30 that manages transfers of data to and from the IDE bus 16, which is connected to the host adapter 15 of the host computer 12. A DRAM controller 34 controls access to the DRAM 32, in which a portion of the DRAM 32 stores data transferred to and from the disc 26, and another portion of the DRAM 32 is allocated for the command queue 36. The command queue 36 is structured as a ring buffer that can store a preset number (e.g., 32) of command packets.

A command queue controller 38 manages transfers of the command packets from the IDE bus 16 to the command queue 36. Upon identifying that a command packet is received from the IDE bus 16, the command queue controller 38 sends a request to the DRAM controller 34 by changing the signal level of a signal line 41 from logic 0 to logic 1, requesting the DRAM controller 34 to store the command packet into the command queue 36. As described below, the command queue controller 38 dynamically changes the priority of the request over time.

The DRAM controller 34 includes a DRAM arbiter 40 that arbitrates the requests from the command queue controller 38 and requests from other units (such as a command queue reader 42 or an error correction encoder, not shown) that require access to the DRAM 32. The DRAM arbiter 40 determines the sequence in which the requests are executed by the DRAM controller 34, the arbitration process partly based on the priority of the requests. In one example, the priority of a request is based on the source of the request (i.e., the module that sent the request) and a priority value associated with the request. For example, a request from the error correction decoder can be designated to have a higher priority than a request from the command queue controller 38. The priority of requests from different sources can be specified in a lookup table that is initialized at startup. The priority values can be specified by the module that sent the request. In one example, the command queue controller 38 specifies the priority value on a signal bus 43 that is 2 bits wide, which supports four priority levels.

When a command packet is received from the IDE bus 16, the command queue controller 38 initially sets the priority value on signal bus 43 to a lower priority (e.g., priority value=0). After sending a request to the DRAM arbiter 40 by pulling the signal line 41 to logic 1, the command queue controller 38 monitors whether the command packet has been processed by the DRAM controller 34 by storing the command packet in the DRAM 32 or in a buffer of the DRAM controller 34. If, after a period of time, the command packet has not been processed by the DRAM controller 34, the command queue controller 38 increases the priority value on the signal bus 43. By increasing the priority value, the DRAM arbiter 40 is likely to select the request on signal line 41 ahead of the other requests having lower priorities. The command queue controller 38 continuously monitors whether the command packet has been processed by the DRAM controller 34, and increases the priority value until the command packet is processed by the DRAM controller 34.

By initially setting a lower priority value for the request to store the command packet into the command queue 36, more memory bandwidth can be allocated to perform other tasks, such as background buffering. Background buffering refers to pre-fetching data from the disc 26, and storing the pre-fetched data to the memory 32 to allow faster access to the data at a later time. By increasing the priority value of the requests to save the command packet to the command queue 36 after a preset period of time, the command queue controller 38 can ensure that the command packet will not wait indefinitely to be transferred from the IDE bus 16 to the DRAM 32, and in most cases can be transferred within a predetermined amount of time. This is useful when the IDE bus 16 has a limited wait period between successive command packets. If a command packet is not written into the command queue 36 within a certain amount of time, a new command packet arrives, and the previous command packet is lost.

The microcontroller 44 interprets the command packets and performs operations according to the command packets. The microcontroller 44 sends requests to a command queue reader 42 to obtain a command packet from the command queue 36. The command queue reader 42 sends requests to the DRAM controller 34 to request access to the command queue 36. Similar to the requests sent from the command queue controller 38, the requests sent from the command queue reader 42 are arbitrated by the DRAM arbiter 40 to determine the sequence in which the requests are executed by the DRAM controller 34.

Examples of the command packets include read and write commands. For example, a “read sector” command packet may specify that a number of sectors of data are to be read from the disc 26 and sent to the IDE bus 16. The data read from the disc 26 are stored in the DRAM 32, transferred from the DRAM 32 to an output first-in-first-out (FIFO) buffer 46, then transferred from the output FIFO buffer 46 to the IDE bus 16. A “write sector” command packet may specify that a number of sectors of data are to be received from the IDE bus 16 and written to the disc 26. The data received from the IDE bus 16 are stored in an input FIFO buffer 48, transferred from the input FIFO buffer 48 to the DRAM 32, then transferred from the DRAM 32 to the disc 26.

In one example, the input FIFO 48, the output FIFO 46, the command queue reader 42, and the DRAM controller 34 are connected to a DRAM controller interface 68 that is 16 bits wide. Data are transferred from the FIFO output buffer 46 to the IDE bus 16 through a signal path 70 that is 16 bits wide, and data are transferred from the IDE bus 16 to the input FIFO 48 through a signal path 72 that is 16 bits wide.

When a command packet appears on the IDE bus 16, the command packet is first stored in an IDE latch 66 in the command queue controller 38. The command queue controller 38 sends requests to the DRAM controller 34 to request that the command packets be transferred from the IDE latch 66 to the command queue 36. In one example, the IDE latch 66 includes 16 bits, and command packets are transferred from the IDE bus 16 to the IDE latch 66 through a signal path 74 that is 16 bits wide. The command packets are transferred from the IDE latch 66 to the command queue 36 through the DRAM controller 34.

In a write operation, prior to saving the data received from the IDE bus 16 to the disc 26, the data is encoded according to an optical storage standard (such as digital versatile disc standard) to generate channel codes that include error correction information and having a format suitable for storing in the disc 26. In a read operation, the data read from the disc 26 are decoded according to the optical storage standard, and errors in the data are corrected using the error correction information.

As described above, by storing multiple command packets in the command queue 36, the microcontroller 44 can read multiple command packets and rearrange the order of execution of the command packets to achieve a higher efficiency in accessing the disc 26. For example, the order of executing the command packets may be rearranged to reduce the back-and-forth movement of the pickup head 24 when accessing the tracks on the disc 26. Command packets for read and write operations may be interleaved to increase data throughput.

The disc drive 14 may enter a stand-by mode when the disc drive has been idle for a specified period of time. In one example, during the stand-by mode, the system clock is turned off and not provided to the various devices of the drive 14, while a crystal oscillator and a phase lock loop circuitry continues to operate. When the microcontroller 44 determines that the drive 14 has been idle for the preset period of time, the microcontroller 44 sets the value of a stand-by bit in a register of a power management block (not shown) in the microcontroller 44 to logic 1.

When the command queue controller 38 detects that an incoming command packet has been received from the IDE bus 16 and needs to be saved into the command queue 36, the command queue controller 38 sends a reset signal (not shown), referred to as the packet_command_wakeup signal, to the microcontroller 44 (e.g., by setting the signal line of the packet_command_wakeup signal to logic 1). Upon detecting that the packet_command_wakeup signal has a logic 1 value, the microcontroller 44 sets the value of the stand-by bit to logic 0. When the packet_command_wakeup signal has a logic 1 value, the microcontroller 44 does not set the stand-by bit to logic 1, thus preventing the drive 14 from entering the stand-by mode. When the incoming command packet is safely stored in the DRAM 32, and no other incoming command packet has been detected, the command queue controller 38 sets the packet_command_wakeup signal to logic 0, allowing the microcontroller 44 to set the disc drive 14 into the stand-by mode after a preset period.

The disc drive 14 can also enter a sleep mode, in which the power to most of the components of the drive 14 is reduced or cut off, and the crystal oscillator and the phase lock loop circuitry is turned off. Power continues to be supplied to a small number of devices, such as the DRAM 32 that requires refreshing of memory cells, to ensure proper operation when the disc drive 14 awakes from the sleep mode.

In one example, when the host computer 12 sends a PACKET command (command code 0xA0) to the disc drive 14 while the disc drive is in the sleep mode, the command queue controller 38 awakes from the sleep mode, and activates the system clock circuit to generate the system clock signal so that the drive circuitry can be synchronized. The microcontroller 44 sends a request through a signal line 49 to the command queue controller 38 to request transfer of the command packet from the IDE bus 16 to the command queue 36. When the command queue controller 38 determines that the command packet has been saved into the command queue 36, the command queue controller 38 sends an interrupt signal through a signal line 50 to the microcontroller 44. The command queue controller 38 also sends the address of the command packet in the command queue 36 to the microcontroller 44 through a signal line 52. Upon receiving the interrupt signal on line 50, the microcontroller 44 either reads the command packet from the command queue 36, or saves the address of the command packet on line 52 in the DRAM 32 for later use.

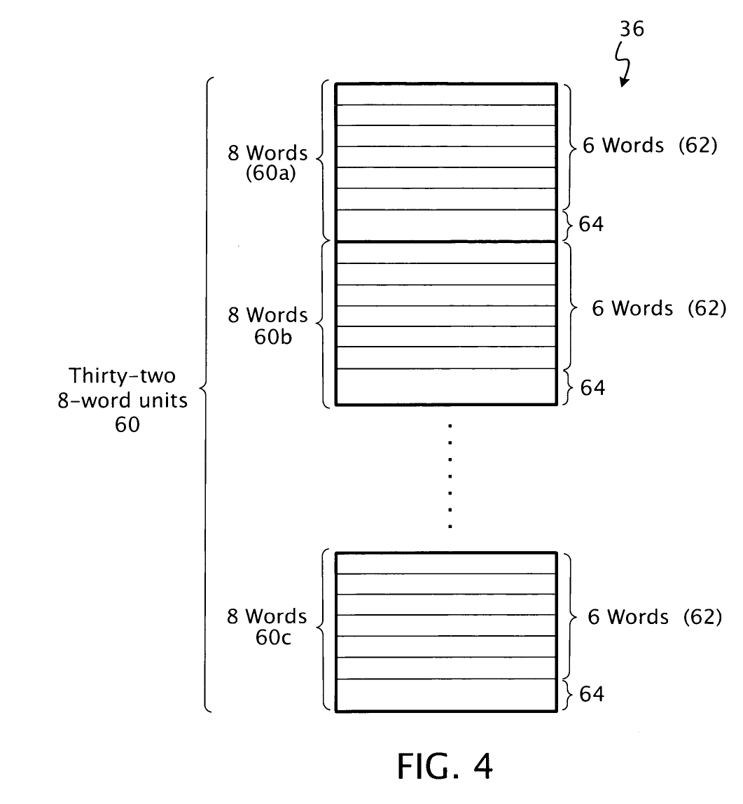

FIG. 4 shows an example of the command queue 36 that uses 512 bytes of memory space in the DRAM 32. The command queue 36 includes thirty-two units 60 (individually referenced as, e.g., 60a, 60b, and 60c), each unit 60 having sixteen bytes (or eight words). Each unit 60 stores a command packet 62, which includes up to 12 bytes, and up to four bytes of additional information 64, such as a word count limit (which occupies 15 bits and is used by the host computer 12 to notify the drive 14 about the maximum transfer length per transfer in a programmed input/output mode) and feature information (which occupies 1 bit and is used by the host computer 12 to notify the drive 14 whether the following transfer uses programmed input/output mode or direct memory access mode). The four bytes of information 64 can also be used by the microcontroller 44.

The command queue 36 can be configured as a ring buffer. Initially, the command queue 36 is empty. The first command packet is stored in the first 16-byte unit 60a, the second command packet is stored in the second 16-byte unit 60b, and so forth.

In one example, after a command packet is stored in the last 16-byte unit 60c, the command queue controller 38 checks whether the command packet stored in the first 16-byte unit 60a has been executed. Because the microcontroller 44 may execute the command packets in the command queue 36 in an order that is different from the order in which the command packets are stored in the command queue 36, it is possible that the command packet stored in the first 16-byte unit 60a has not been executed while a command packet stored in the second 16-byte unit 60b or a later location has already been executed. When a new command packet arrives, the command queue controller 38 searches for a location in the command queue 36 in which a command packet stored at that location has already been executed, and stores the new command packet at the location, overwriting the already-executed command packet.

Afterwards, each time when there is a new command packet that needs to be stored in the command queue 36, the command queue controller 38 searches for the next location in which the command packet has already been executed, and overwrites the already-executed command packet with the new command packet.

In the example above, the command queue 36 uses 512 bytes of memory space. Alternatively, the memory space occupied by the command queue 36 can also be dynamically adjusted by the microcontroller 44. The microcontroller 44 may adjust the size of the command queue 36 based on the amount of free memory space available in the DRAM 32. The size of the command queue 36 may be adjusted based on the type of optical disc 26 being accessed. The size of the command queue 36 may also be adjusted based on historical data about the performance of the disc drive. For example, based on historical data, the microcontroller 44 may determine that the data transfer rate is likely to have a higher value when the command queue 36 has a size sufficient to store a certain number of command packets.

When the host computer 12 intends to send command packets to the disc drive 14, the host computer 12 sends a command code 0xA0. In one example, the IDE bus 16 and the circuit 30 are configured to comply with serial AT attachment (SATA) interface standard. Upon receiving the 0xA0 command code, a transport layer of the disc drive 14 returns a programmable input/output (PIO) set up frame information structure (FIS) to the host computer 12, indicating that the disc drive 14 is ready to receive command packets. In another example, the IDE bus 16 and the circuit 30 are configured to comply with parallel ATA interface standard. Upon receiving the 0xA0 command code, the disc drive 14 sets a data request signal, clears a busy signal, and may send an interrupt to notify the host computer 12 that the disc drive 14 is ready to receive command packets.

When a SATA interface is used, because of the high speed at which data are transferred through the interface, an additional buffer (not shown) is used to store data received from the SATA interface.

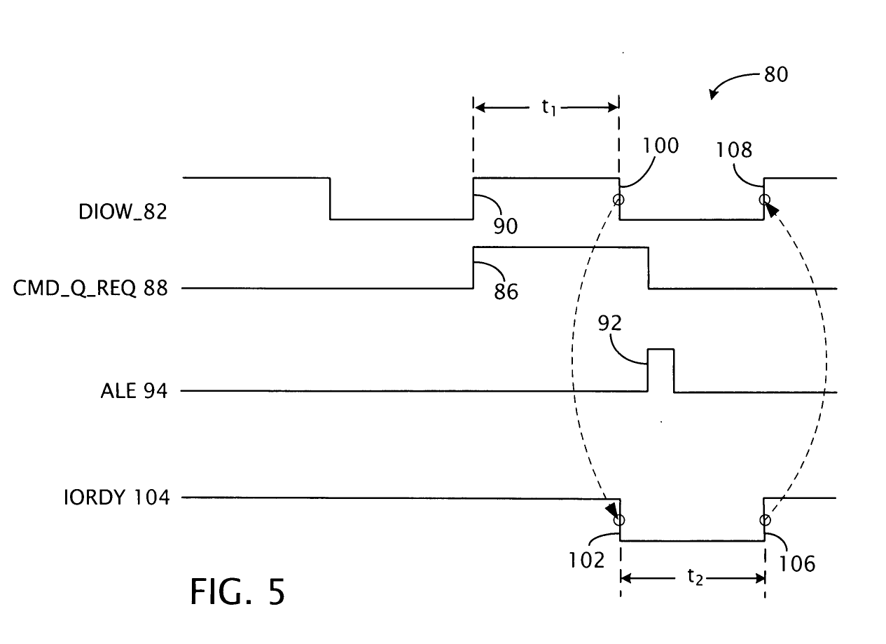

FIG. 5 shows graphs 80 of signals associated with the transfer of command packets from the IDE bus 16 to the command queue 36. The IDE bus 16 includes a signal line for sending a drive input/output write (DIOW_) signal 82, which is a write strobe signal issued by the host adapter 15. When the host adapter 15 sends a command packet, the host adapter 15 toggles the DIOW_signal line six times (each command packet has six words, and the IDE latch 66 can only store one word), in which data are valid at the rising edge (e.g., 90) of the DIOW_signal 82. Here, data refers to portions of the command packet. Because the IDE latch 66 is 16 bits (one word) wide, the host adapter 15 transfers one word of data at a time.

At the rising edge 90, the host adapter 18 sends the data to the signal lines (e.g., signal lines D0 to D15) of the IDE bus 16. Upon detecting that there are valid data (portions of the command packet) on the IDE bus 16, the command queue controller 38 sends a request signal 88 (CMD_Q_REQ) by changing the signal levels on the signal line 41 to notify the DRAM arbiter 40 that there are data to be transferred from the IDE latch 66 to the command queue 36. The DIOW_signal 82 is pulled high for a period of time t₁, which is the recovery time required before the host adapter 15 can send a new piece of data.

During initialization of the disc drive 14, the microcontroller 44 sets the start and end addresses (or the start address and the queue size) of the command queue 36. Based on this information, the command queue controller 38 determines the destination address in the command queue 36 where the six words of the command packet are stored, and sends a destination address to the DRAM controller 34 through an address bus (not shown).

After the request signal 88 is pulled high 86, the DRAM controller 34 latches the destination address of the command packet, and pulls high 92 an address latch enable (ALE) signal 94 for a short period of time to indicate that the information on the address bus can be changed. The DRAM controller 34 latches the data (in this case, one word of the command packet) and stores the data in the destination address.

When the ALE signal is pulled high 92, if there are additional data (e.g., other words of the command packet or another command packet) that need to be stored in the DRAM 32, the command queue controller 38 will maintain the request signal 88 at a high level, and the command queue controller 38 will send the destination address of the next data to the DRAM controller 34. For example, a command packet includes six words, and the IDE latch 66 stores only one word, so the DRAM controller 34 will have to transfer the data in the IDE latch 66 to the command queue 36 six times for each command packet. If there are no more data that need to be stored in the DRAM 32, the command queue controller 38 will pull the request signal 88 low.

After the host adapter 15 pulls the DIOW_signal 82 high 90 for a period of time t₁, the host adapter 15 pulls the DIOW_signal 82 low 100, preparing to send the next data. The host adapter 15 assumes that the data will be successfully transferred to the DRAM 32 after the time period t₁. However, because the request from the command queue controller 38 initially has a lower priority, the data may not be processed by the DRAM controller 34 within the time period t₁. Thus, when the DIOW_signal 82 is pulled low 100, the command queue controller 38 examines whether the data in the IDE latch 66 has been processed by the DRAM controller 34 (either saving the data into the command queue 36 or a buffer of the DRAM controller 34). If the data has not been processed by the DRAM controller 34, the command queue controller 38 pulls low 102 an input/output ready (IORDY) signal 104.

The low IORDY signal 104 notifies the host adapter 15 that the write strobe needs to be extended, indicating that the disc drive 14 is not ready to receive new data. After the command queue controller 38 determines that the data in the IDE latch has been processed by the DRAM controller 34, the IORDY signal 104 is pulled high 106, indicating that the data in the IDE latch 66 has been processed by the DRAM controller 34. Subsequently, the DIOW_signal 82 is pulled high 108 by the host adapter 15.

In one example, the write strobe can be extended up to 1250 ns. This means that an time interval t₂ between the falling edge 102 and the rising edge 106 of the IORDY signal 104 has to be less than 1250 ns. To ensure that the data in the IDE latch 66 is processed by the DRAM controller 34 before the 1250 ns limit, the command queue controller 38 sets the priority value on signal bus 43 to a higher value at about 375 ns before the 1250 ns limit. The 375 ns provide sufficient time for the DRAM arbiter 40 to perform arbitration and to allow the DRAM controller 34 to process the request from the command queue controller 38.

In the example shown in FIG. 3, there is one 16-bit IDE latch 66 that latches one word. Each command packet has six words and requires six transfers from the IDE latch 66 to the command queue 36. Before the six words of a command packet is completely transferred to the command queue 36, another module (e.g., the error correction decoder or the command queue reader 42) may access the DRAM 32. Different modules may access different pages of the DRAM 32, which result in a longer access time. To increase efficiency, a second stage of data latch may be used in series with the IDE latch 66. The two data latches can store two words of a command packet. The command queue controller 38 will send three requests to the DRAM controller 34 to request transfers of data from the data latches to the command queue 36. To further increase efficiency, three stages of data latches in series may be used. In this case, the command queue controller 38 will send two requests to the DRAM controller 34 to request transfers of data from the data latches to the command queue 36.

When the command queue controller 38 transfers a command packet from the IDE latch 66 to the command queue 36, the command queue controller 38 sends the starting address of the first word of the command packet to the microcontroller 44 through the signal line 52. The microcontroller 44 writes this address into read address registers, and subsequently performs read operations to read the command packet from the command queue 36.

In some examples, the microcontroller 44 interacts with the DRAM controller 34 directly. The microcontroller 44 reads from the address of the first word of the command packet, in which the address was provided by the command queue controller 38. The microcontroller 44 then reads the remaining portions of the command packet by successively increasing the read address by one, reading one word of the command packet at a time.

In some examples, the microcontroller 44 interacts with a command queue reader 42 to retrieve the command packet from the command queue 36. The microcontroller 44 reads from a predetermined address, referred to as a command/data port. In response, the command queue reader successively issues read requests to the DRAM controller 34, each time increasing the read address by two (each read request retrieves two bytes), so that the entire command packet is read from the command queue 36. In this way, the microcontroller 44 can read the entire command packet from the same address (the command/data port), allowing the microcontroller 44 to allocate more of its computation resources to other tasks. The command packets can be read from the command queue 36 faster this way.

In the situation where the microcontroller 44 does not read the command packet from the command queue 36 upon receiving the address of the first word of the first command packet from the command queue controller 38, the microcontroller 44 stores the address of the first word at a location in the DRAM 32. Later, when the microcontroller 44 intends to start reading the command packets, the microcontroller 44 reads the address of the first word from the DRAM 32, and sends the address to the command queue reader 42. The microcontroller 44 successively reads from the command/data port, which receives data that the command queue reader 42 reads from the command queue 36.

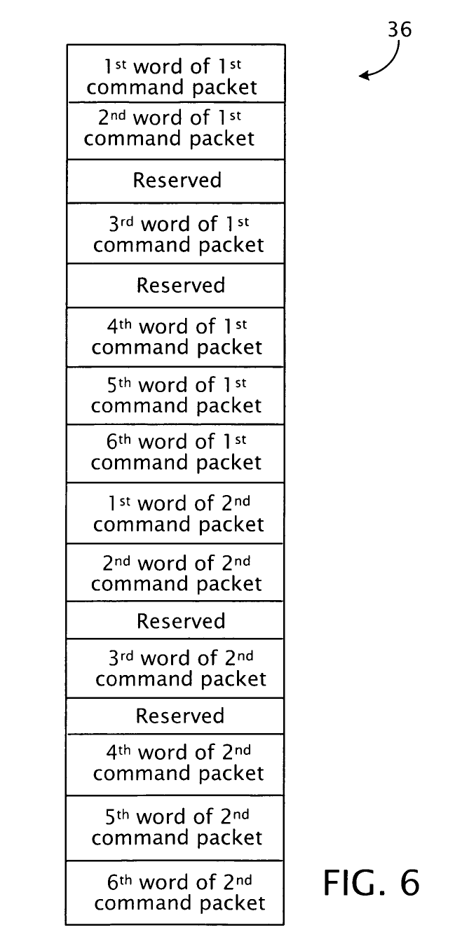

FIG. 6 shows an example of the command queue 36, in which the reserved words are positioned between the 2nd and 3rd words, and between the 3rd and 4th words of each 8-word unit. The placement of the reserved words can be different from that of FIG. 6.

Although some examples have been discussed above, other implementations and applications are also within the scope of the following claims. For example, the circuit 30 can be used in a hard disk drive instead of an optical disc drive. The IDE bus 16 may be replaced by data buses the comply with other interface standards. The sizes of the command packets, the command queue 36, the IDE latch 66, the input FIFO 48, and the output FIFO 46 may be different. The bit widths of the signal paths shown in FIG. 3 may be different. The signal bus 43 can be more than 2 bits wide, supporting more than four priority levels. The DRAM 32 may be replaced by other types of memory devices, such as static random access memory (SRAM). The signal sequence shown in FIG. 5 may be different.

What is claimed is:

1. An optical storage device comprising:
a memory, the memory including a command queue to store advanced technology attachment (ATA) commands sent by a host device; and
a controller capable of executing the commands such that at least a subset of the commands are executed in a sequence that is different from a sequence in which the commands are sent by the host device.

2. The optical storage device of claim 1 in which the controller executes the commands in a sequence that tends to reduce the total amount of time required for executing the commands.

3. The optical storage device of claim 1 in which the controller executes the commands in a sequence that tends to reduce the total amount of distance traveled by a pickup head of the optical storage device when executing the commands.

4. The optical storage device of claim 1 also comprising a second controller to control transfers of the commands to the command queue.

5. The optical storage device of claim 4 in which the second controller, upon receiving a new command, searches for a location in the command queue in which a command previously stored at the location has already been executed, and stores the new command in the location.

6. The optical storage device of claim 1 in which the controller also controls transfers of commands to the command queue.

7. The optical storage device of claim 6 in which the controller, upon receiving a new command, searches for a location in the command queue in which a command previously stored at the location has already been executed, and stores the new command in the location.

8. The optical storage device of claim 1 also comprising a serial ATA (SATA) interface, in which the commands from the host device are transmitted to the optical storage device through the SATA interface.

9. The optical storage device of claim 1 also comprising a parallel ATA (PATA) interface, in which the commands from the host device are transmitted to the optical storage device through the PATA interface.

10. The optical storage device of claim 1 also comprising a command queue reader to read the commands from the command queue and forward the commands to a command/data port, in which the controller reads the commands from the command/data port.

11. The optical storage device of claim 1 in which the ATA commands comprises ATA packet interface (ATAPI) command packets.

12. An apparatus comprising:
a command controller to manage transfer of a command packet from a data bus to a memory by sending a request to a memory controller requesting the memory controller to store the command packet or a portion of the command packet into the memory, the command controller being capable of sending the request in a higher priority than another request to the memory controller.

13. The apparatus of claim 12 in which the data bus complies with at least one of a serial AT attachment (ATA) interface standard and a parallel ATA interface standard.

14. The apparatus of claim 12 in which the memory comprises a cache memory of a storage device.

15. The apparatus of claim 14 in which the storage device comprises at least one of a hard disk drive and an optical disc drive.

16. The apparatus of claim 14 in which the command packets comprise at least one of a read data command to read data from the storage device and a write data command to write data to the storage device.

17. The apparatus of claim 12, further comprising a memory arbiter to arbitrate which request to access the memory is executed by the memory controller, the arbitration based at least in part on the priority of the request.

18. The apparatus of claim 12 in which the memory comprises at least one of dynamic random access memory and static random access memory.

19. The apparatus of claim 12 in which the memory comprises a command queue to store multiple command packets.

20. The apparatus of claim 12 in which the command controller prevents the apparatus from entering a stand-by or sleep mode before the command packet is stored into the memory.

21. An apparatus comprising:
a storage device;
a memory;
a memory controller to control access to the memory; and
a command controller to manage transfers of command packets from a data bus to the memory, the command controller sending a request to the memory controller to request a command packet or a portion of the command packet to be stored in the memory, the command controller being capable of adjusting a priority level of the request over time, and the command packets including at least one of a read command to read data from the storage device and a write command to write data to the storage device.

22. The apparatus of claim 21 in which if the command packet is not processed by the memory controller after a period of time, the command controller increases the priority level of the request.

23. The apparatus of claim 21 in which the data bus complies with at least one of a serial AT attachment (ATA) interface standard and a parallel ATA interface standard.

24. The apparatus of claim 21, further comprising a memory arbiter to arbitrate which request to access the memory is sent to the memory controller, the arbitration based at least in part on priority levels of the requests.

25. The apparatus of claim 21 in which the memory comprises at least one of dynamic random access memory and static random access memory.

26. The apparatus of claim 21 in which the storage device comprises at least one of a hard disk drive and an optical disc drive.

27. The apparatus of claim 21 in which the memory comprises a cache memory, at least a portion of the memory to temporarily store data to be written to the storage device and data read from the storage device.

28. The apparatus of claim 21, further comprising a host computer that accesses the storage device using the data bus.

29. A storage device comprising:
a command queue to store command packets that are received from a host device and are used to control an operation of the storage device, the command queue having a variable size; and
a controller to determine the size of the command queue based on predetermined criteria.

30. The storage device of claim 29 in which the storage device comprises at least one of a hard disk drive and an optical disc drive.

31. The storage device of claim 29 in which the command queue is part of a random access memory, and the controller determines the size of the command queue based on an available amount of free space in the random access memory.

32. The storage device of claim 29 in which the controller determines the size of the command queue based on historic data relating performance of the storage device to the size of the command queue.

33. A method comprising:
receiving advanced technology attachment (ATA) commands at an optical storage device having a memory;
storing the commands in a command queue in the memory; and
executing the commands, at least a subset of the commands being executed in a sequence that is different from a sequence in which the commands are received at the optical storage device.

34. The method of claim 33 in which executing the commands comprises executing the commands in a sequence that tends to reduce the total amount of distance traveled by a pickup head of the optical storage device when executing the commands.

35. The method of claim 33 in which executing the commands comprises executing the commands in a sequence that tends to reduce the total amount of time required for executing the commands.

36. The method of claim 33 also comprising, upon receiving a new command, searching for a location in the command queue in which a command previously stored at the location has already been executed, and storing the new command in the location.

37. The method of claim 33 also comprising sending the commands to the optical storage device through a serial ATA interface.

38. The method of claim 33 also comprising sending the commands to the optical storage device through a parallel ATA interface.

39. The method of claim 33 also comprising reading the commands from the command queue, forwarding the commands to a command/data port, and using the controller to read the commands from the command/data port.

40. The method of claim 33 in which, if the command comprises a write command, executing the command comprises writing all data to the optical storage medium as instructed by the command.

41. The method of claim 33 in which, if the command comprises a read command, executing the command comprises reading all data from the optical storage medium as instructed by the command.

42. The method of claim 33 in which the ATA commands comprises ATA packet interface (ATAPI) command packets.

43. A method comprising:
sending a request to a memory controller that controls access to a memory to request the memory controller to store a command packet or a portion of the command packet in the memory; and
if the command packet or a portion of the command packet is not processed by the memory controller after a period of time, increasing a priority level of the request.

44. The method of claim 43 in which the command packet controls an operation of a peripheral device that includes the memory.

45. The method of claim 43, further comprising receiving the command packet from a data bus that is compatible with at least one of a serial AT attachment (ATA) interface standard and a parallel ATA interface standard.

46. The method of claim 43 in which the command packet is sent from a host computer to the data bus, and the memory controller and the memory are disposed at a peripheral device.

47. The method of claim 46 in which the peripheral device comprises at least one of a hard disk drive and an optical disc drive.

48. The method of claim 46 in which the peripheral device enters a sleep mode in which power consumption is reduced.

49. The method of claim 48, further comprising preventing the peripheral device from entering the sleep mode before the command packet is stored in the memory.

50. The method of claim 43 in which the command packets comprise at least one of a read data command to read data from a storage device and a write data command to write data to the storage device.

51. The method of claim 43, further comprising sending more than one request to the memory controller, and arbitrating the requests to determine a sequence in which the requests are executed by the memory controller, the arbitration based at least in part on the priorities of the requests.

52. The method of claim 43, further comprising storing the command packets in a command queue that can simultaneously store multiple commands.

53. The method of claim 43, further comprising successively increasing the priority level of the request until the command packet or a portion of the command packet is processed by the memory controller.

54. A method comprising:
preventing a peripheral device to enter a sleep mode before a command packet received by the peripheral device is saved in a memory,
wherein the peripheral device has a command controller to manage transfers of command packets from the host device to the memory by sending requests to a memory controller requesting the memory controller to store the command packets or portion of the command packets in the memory, the command controller being capable of adjusting priority levels of the requests.

55. The method of claim 54 in which the peripheral device comprises at least one of a hard disk drive and an optical disc drive.

56. The method of claim 54, further comprising receiving the command packets through a data bus that is compatible with at least one of a serial AT attachment (ATA) interface standard and a parallel ATA interface standard.

57. A method comprising:
determining a size of a command queue for storing command packets received at a peripheral device and sent from a host device, the peripheral device having a memory, the command packets including commands for controlling an operation of the peripheral device; and
allocating a portion of the memory to store the command queue.

58. The method of claim 57 in which the peripheral device comprises at least one of a hard disk drive and an optical disc drive.

59. The method of claim 57 in which the size of the command queue is determined based at least in part on an available amount of free space in the memory.

60. The method of claim 57 in which the size of the command queue is determined based at least in part on historic data relating performance of the peripheral device to the size of the command queue.

61. The method of claim 57, further comprising executing the command packets in the memory in a sequence that is different from a sequence in which the command packets are received at the peripheral device.
